(19) United States
(12) Patent Application Publication
(10) Pub. No.: US 2014/0314896 A1
(43) Pub. Date: Oct. 23, 2014

(54) PRINTED MOLD AND TEXTURED PANELS FORMED USING THE SAME

(71) Applicant: 3form, Inc., Salt Lake City, UT (US)

(72) Inventors: Matthew T. Sutton, Salt Lake City, UT (US); John E.C. Willham, Sandy, UT (US); Charles H. Moore, Salt Lake City, UT (US); M. Hoyt Brewster, Salt Lake City, UT (US)

(73) Assignee: 3form, Inc., Salt Lake City, UT (US)

(21) Appl. No.: 14/213,945

(22) Filed: Mar. 14, 2014

Related U.S. Application Data
(60) Provisional application No. 61/792,296, filed on Mar. 15, 2013.

(51) Int. Cl. B29C 33/38; B29C 59/02

(52) U.S. Cl. CPC B29C 33/3842; B29C 59/02
USPC 425/385; 427/133

(57) ABSTRACT

Implementations of the present disclosure relate to systems, methods, and apparatus for finishing polymer products and producing one or more designs, textures, and/or embossment patterns on the surface thereof. At least one implementation includes a printed mold that a manufacturer can produce quickly and inexpensively by producing a three-dimensional representation of a two-dimensional image on the surface of a substrate material. The printed mold also can allow the manufacturer to customize designs, textures, and/or embossment patterns on polymer products, while reducing manufacturing costs.

### CROSS-REFERENCE TO RELATED APPLICATIONS

The present application claims the benefit of priority to U.S. Provisional Application No. 61/792,296, filed Mar. 15, 2013, entitled “Printed Mold and Textured Panels Formed Using the Same,” the entire content of which is incorporated by reference herein.

### BACKGROUND

1. The Field of the Disclosure

This disclosure relates to systems, methods, and apparatus for texturing, embossing, and/or finishing polymer products.

2. Background and Relevant Art

Recent trends in building design involve using one or more sets of decorative panels to add to the functional and/or aesthetic characteristics of a given structure or design space. Some recent architectural designs have implemented synthetic thermoplastic polymer panels for use as partitions, displays, barriers, lighting diffusers, decorative finishes, etc. Polymer panel materials may include, for example, poly vinyl chloride (PVC); polyacrylate materials such as poly (methyl methacrylate) (PMMA); polyester materials such as poly (ethylene-co-cyclohexane 1,4-dimethanol terephthalate) (PET) or poly (ethylene-co-cyclohexane 1,4-dimethanol terephthalate glycol) (PETG); glycol modified polycyclohexylenedimethlene terephthalate (PCTG); 1,4-cyclohexanedimethanol (CHDM); polycarbonate (PC) materials, and the like. Materials used in producing polymer panels may also include any number of similar polymers or polymer alloys that trace their component origins to derivatives of petroleum processing.

Polymer panels may be popular compared with decorative cast or laminated glass panels, since polymer panels are generally more resilient and have a lower specific gravity than glass panels, while having a similar transparent, translucent, or decorative appearance. Decorative polymer panels may also provide greater design flexibility as compared with glass panels, at least in terms of color choices, degree of texture, thickness, and overall physical characteristics, such as flexibility and impact resistance. Furthermore, decorative polymer panels have wide utility since manufacturers can easily and inexpensively form and fabricate single or multi-layer laminate polymer panels that include a large variety of artistic designs, images, shapes, structures, and assemblies. Manufacturers can economically produce polymer panels as either flat sheets or three-dimensional (i.e., curved or shaped) formations, that can potentially include compound curvatures. As a result, polymer panels have a fairly wide functional and aesthetic utility, and provide designers and architects with the ability to readily change the design and function of new and existing structures.

For example, various polymer products incorporate textured or embossed surfaces. Texture and/or embossments on the product's surface may have aesthetic as well as functional purposes. For instance, texture can scatter light passing through a polymer panel, such that the polymer panel can obscure the view of an onlooker. Additionally or alternatively, texture can provide aesthetically pleasing appearance to the product.

Generally, a manufacturer can impart texture or embossments onto the polymer product by incorporating a mirrored, negative of the desired texture into a surface of a mold, which will contact or press against a corresponding portion of the polymer product. The manufacturer can construct such a mold from steel or aluminum. Ordinarily, to create texture or embossments in the mold, the manufacturer machines the mold to remove material. Machining of texture and/or embossments can increase manufacturing costs of the mold as well as of the finished polymer product. Once machined, the mold typically cannot be re-machined and/or reused for producing products that have different texture and/or embossments thereon. Furthermore, commonly used molds may wear with continued use. Heavily worn molds may not transfer all details of a finely detailed texture and/or embossment pattern, requiring construction of a new mold.

In some instances, the manufacturer can use texturing rollers to impart desired embossment patterns and/or texture onto the polymer panel. For example, a steel or aluminum roller can have multiple protrusions that can form corresponding indents in the polymer panel. Similar to the molds that incorporate texture and/or embossments, machining may be required for manufacturing such texturing rollers or plates, which can be expensive. Furthermore, the texturing rollers and plates may not impart a desired level of detail of texture and/or embossments on the polymer sheet.

Accordingly, there are a number of disadvantages in the devices and methods for producing texture and/or embossments on polymer products that can be addressed.

### BRIEF SUMMARY

Implementations of the present disclosure solve one or more of the foregoing or other problems in the art with systems, methods, and apparatus for producing textured and/or embossed polymer products and/or manufacturing a mold configured to provide the same. In particular, at least one implementation includes a mold having raised portions, and which can be used to produce texture and/or embossment in or on polymer panels. In certain implementations, the raised portions may be printed, deposited, or otherwise applied to a surface of the mold. A manufacturer can produce such a printed mold quickly and inexpensively by using laser or inkjet printing to form the raised portions. Furthermore, a manufacturer can produce such molds with intricate details with relative ease. Thus, such printed molds can allow the manufacturer to customize texture and/or embossment patterns on polymer products, while avoiding a significant increase in cost that may be associated with traditional custom manufacturing. Thus, one or more implementations of the present disclosure allow for a manufacturer to quickly and easily take a two-dimensional image and form a three-dimensional pattern therefrom.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments and/or implementations thereof which are illustrated in the appended drawings. For better understanding, the like elements have been designated by like reference numbers throughout the various accompanying figures. Understanding that these drawings depict only typical embodiments and/or implementations of the disclosure and are not therefore to be considered to be limiting of its scope, the embodiments and/or implementations will be described and explained with additional specificity and detail through the use of the accompanying drawings in which:

FIG. 1A illustrates a perspective view of a printed mold in accordance with one implementation of the present disclosure;

FIG. 1B illustrates an enlarged portion of the printed mold of FIG. 1A;

FIG. 1C illustrates an end view of an enlarged portion of the printed mold of FIG. 1A;

FIG. 2A illustrates a perspective view of a polymer panel processed using the printed mold of FIG. 1A in accordance with one implementation of the present disclosure;

FIG. 2B illustrates an enlarged portion of the polymer panel of FIG. 2A;

FIG. 2C illustrates a cross-section of an enlarged portion of the polymer panel of FIG. 2A;

FIG. 3A illustrates a perspective view of a printed mold in accordance with another implementation of the present disclosure;

FIG. 3B illustrates an enlarged portion of the printed mold of FIG. 3A;

FIG. 4A illustrates a perspective view of a polymer panel processed using the printed mold of FIG. 3A in accordance with one implementation of the present disclosure;

FIG. 4B illustrates an enlarged portion of the polymer panel of FIG. 4A;

FIG. 5 illustrates an enlarged perspective view of a printed mold in accordance with yet one other implementation of the present disclosure;

FIG. 6 illustrates graphical input used for fabricating the printed mold of FIG. 5 in accordance with one implementation of the present disclosure;

FIG. 7 illustrates a perspective view of a polymer panel processed using a printed mold in accordance with one implementation of the present disclosure;

FIG. 8 illustrates a perspective view of a polymer panel with an interlayer and a texture pattern in accordance with one implementation of the present disclosure;

FIG. 9 illustrates a flowchart of a method for embossing and/or texturing polymer panels in accordance with one implementation of the present disclosure;

FIG. 10 illustrates a flowchart of a method for embossing and/or texturing polymer panels in accordance with another implementation of the present disclosure; and

FIG. 11 illustrates a flowchart of a method for embossing and/or texturing polymer panels in accordance with yet another implementation of the present disclosure.

### DETAILED DESCRIPTION OF THE PREFERRED EMBODIMENTS

Implementations of the present disclosure provide systems, methods, and apparatus for producing textured and/or embossed polymer products and/or manufacturing a mold configured to provide the same. In particular, at least one implementation includes a mold having raised portions, and which can be used to produce texture and/or embossment in or on polymer panels. In certain implementations, the raised portions may be printed, deposited, or otherwise applied to a surface of the mold. A manufacturer can produce such a printed mold quickly and inexpensively by using laser or inkjet printing to form the raised portions. Furthermore, a manufacturer can produce such molds with intricate details with relative ease. Thus, such printed molds can allow the manufacturer to customize texture and/or embossment patterns on polymer products, while avoiding a significant increase in cost that may be associated with traditional custom manufacturing. Thus, one or more implementations of the present disclosure allow for a manufacturer to quickly and easily take a two-dimensional image and form a three-dimensional pattern therefrom.

The manufacturer can press the printed mold against the polymer panel to transfer the embossment and/or texture patterns from the printed mold into or onto the polymer panel (e.g., embossing and/or debossing the polymer panel). More specifically, the manufacturer can heat the polymer panel (directly or indirectly), such that at least the surface has a temperature above the glass transition temperature of the polymer material. As the manufacturer presses the printed mold against the polymer panel, the printed mold can form recesses, embossments, and/or texture into or onto the surface of the polymer panel, which correspond with the raised portions, embossments, and/or texture patterns on the printed mold.

Hence, in one or more implementations, the printed mold (or surface thereof) can have raised, un-raised, and/or recessed areas thereon that can form the embossment and/or texture pattern(s) on the printed mold, and which the manufacturer can transfer to polymer panels as described herein. The manufacturer can form raised and/or recessed areas on or in the printed mold by depositing material on a surface of a substrate. Hence, the deposited material may form the raised areas of the printed mold. Similarly, areas on the substrate (or on the printed mold) that do not have the deposited material can form un-raised and/or recessed areas on the printed mold. Recessed areas can also be formed by machining and/or otherwise removing substrate and/or deposited material where appropriate. Thus, by coordinating locations, shapes, and sizes of the raised and recessed areas on the printed mold, the manufacturer can create a desired pattern thereon.

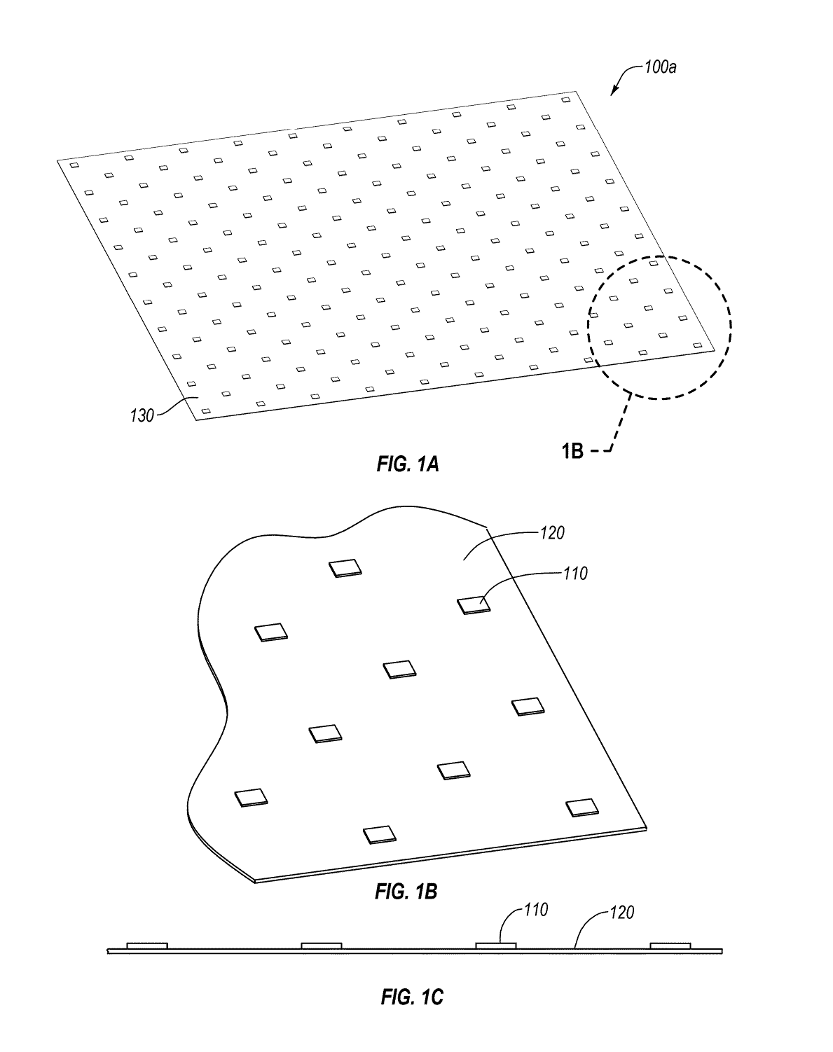

For example, as illustrated in FIGS. 1A-1C, a printed mold 100a can have raised areas 110 and un-raised areas 120 that form an embossment pattern and/or a texture on the printed mold 100a. As noted above, the manufacturer can deposit material on a surface of a substrate 130. FIGS. 1A-1C illustrate an exemplary embossment pattern formed by the raised and un-raised areas 110, 120. In certain illustrative implementations, a printed mold 110a can also have recessed and/or indented areas (not shown) of a substrate 130.

The manufacturer can use a variety of suitable materials for the substrate 130. In one or more implementations, the substrate can have a higher glass transition temperature than the polymer product or panel, on which the manufacturer intends to use the printed mold 100a to create the texturing and/or embossment. Furthermore, the substrate 130 can have a minimum amount of expansion and/or shrinkage in response to increases and decreases in temperature, respectively, such that the pattern of raised, un-raised, and/or recessed areas remains substantially unchanged during processing.

Generally, the substrate 130 can comprise any suitable material that can receive a desired amount or thickness of the deposited material thereon. For example, to minimize shrinkage, the substrate 130 can have a crystalline structure (e.g., bi-axially oriented crystal structure, polymeric crystalline structure, etc.). In additional or alternative implementations, the substrate 130 comprises a polycarbonate sheet, an aluminum sheet, a silicone sheet, etc.

The substrate 130 also can have a desired degree of flexibility and/or rigidity as may be necessary to accommodate a particular shape of the polymer product. The flexibility and/or rigidity of the substrate 130 can depend on the particular material used as well as on the thickness thereof. For instance, the substrate 130 can comprise polycarbonate crystalline polymer and can have a thickness of approximately 1 mm. Accordingly, the substrate 130 can have substantial flexibility, which can allow the printed mold 100a to flex and/or deform about the polymer panel. Alternatively, the substrate 130 can have a sufficient thickness to remain substantially rigid while the manufacturer presses the printed mold 100a against the polymer panel.

As noted above, the manufacturer can form the raised areas 110 by depositing material onto a surface of the substrate 130. For example, the manufacturer can deposit one or more layers of ink or other suitable material onto the surface of the substrate 130, thereby forming the raised areas 110. Thus, the manufacturer can form the raised areas 110 with desired height, size, and shape by applying a desired number of layers of ink or other material at desired locations on the surface of the substrate 130.

It is noted that while reference to ink (or specific type(s) of ink) may be made, other materials capable of and/or configured to be deposited on a substrate 130 are also contemplated herein. For instance, a variety of dyes, paints, gels, glues, epoxies, and/or other natural or synthetic materials or substances can, where appropriate, be deposited, applied, and/or printed onto a substrate 130 to form raised areas 110. Certain materials, for example, may require processing (e.g., suspension and/or dissolution in a liquid or other medium) prior to being deposited. Thus, reference to one or more types of ink should not be construed as being limited to the application of commercial, canonical, or other generally accepted types of inks that may be known in the art.

In one implementation, the ink can be a cross-linked water-based ink, which the manufacturer can cure with UV light. Such UV curing can provide a semi-permanent bond between the ink and the substrate 130 and/or reduce chipping, flaking, cracking, and/or deformation of the cured ink and/or pattern thereof. For instance, a first layer of ink can form raised areas 110 that have a height of approximately 1.5 mils (i.e., 1/1500^{th} of an inch; 0.0015 inches), illustratively. Subsequently, the manufacturer can cure the first layer of ink by exposing the first layer of ink to UV light. To achieve additional height for the raised areas 110, the manufacturer can apply additional layers of ink (e.g., on top of the first layer of cured ink). More specifically, the manufacturer can apply a second layer of ink that, together with the first layer, can form raised areas 110 that have approximately 3 mils of height relative to the un-raised surface of the substrate 130.

Additionally, the manufacturer can apply subsequent layers of ink at different locations than the first layer of ink or on top of a portion of the first layer. Accordingly, the manufacturer can form raised areas 110 that have steps therein. For instance, a first step in a raised area 110 can comprise of the first layer of ink deposited on the surface of the substrate 130, and a second step can comprise first and second layers of ink. Thus, in at least one implementation, the first step in the raised area 110 can have a height of approximately 1.5 mils, and the second step can have a height of approximately 3 mils.

In at least one implementation, the ink used for/in forming the raised areas 110 is a printable ink (i.e., an ink capable of being dispensed from a printer (or other ink-depositing device) and of binding to the substrate 130). Consequently, the manufacturer can print a desired image onto the surface of the substrate 130 to obtain a desired embossment and/or texture pattern thereon. For instance, the manufacturer can use a two-dimensional digital image, template, or reference element to create a three-dimensional embossment and/or texture pattern thereof on the printed mold 100a (or substrate 130 thereof). Moreover, the manufacturer can print or deposit the ink on the substrate 130 to form high resolution embossment and/or texture patterns. Hence, when pressed against a heated polymer panel, for instance, the printed mold 100a can impress the desired texture pattern into the polymer panel with a high degree of detail.

Additionally, the material deposited on the substrate 130 (e.g., ink, as described above) can have substantial flexibility. Accordingly, in one or more implementations, the raised areas 110 can have a low relief or draft angle. In other words, the draft angle along the sides of the raised areas 110 need not be as great as one for comparable raised areas in a steel or aluminum tool, as the raised areas 110 can flex and exit the corresponding indents formed in the polymer panel during processing.

In light of this disclosure, those skilled in the art will appreciate that a manufacturer's ability to print the raised areas 110 on the substrate 130 can drastically reduce manufacturing costs associated with making the printed mold 100a and/or textured polymer product. Moreover, the manufacturer can make various printed molds 100a quickly and on demand. For instance, a customer can supply a desired image, such as a photograph or any digital two-dimensional image, and the manufacturer can use the image to quickly and inexpensively make the desired printed mold 100a. Subsequently, the manufacturer can produce finished polymer panels with the custom embossment and/or texture patterns provided by the customer.

Additionally, as noted above, existing, commonly used molds comprise steel or aluminum with machined embossment or texture patterns. Accordingly, the manufacturer cannot typically reuse such molds for different embossment and/or texture patterns. In at least one implementation of the present disclosure, however, the manufacturer can remove the ink from the substrate 130 of the printed mold 100a. Consequently, the manufacturer can reuse the substrate 130 for new and/or different embossment and/or texture patterns, thereby further reducing production costs.

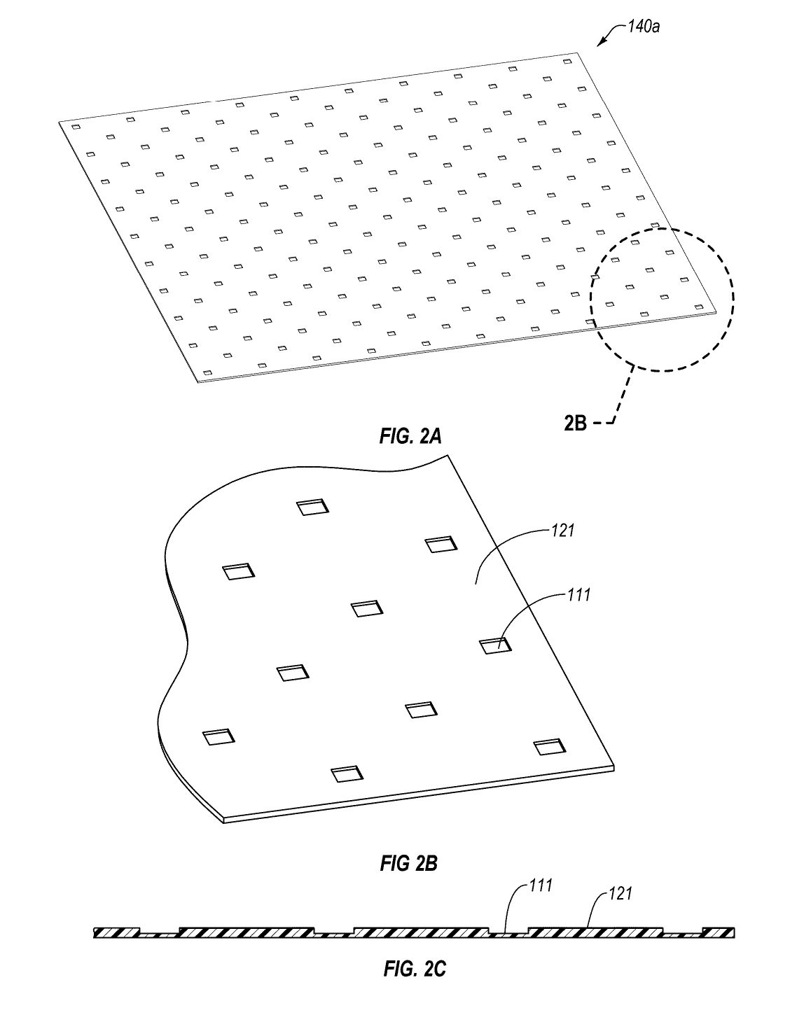

Once prepared, the manufacturer can transfer the embossment and/or texture pattern from the printed mold 100a to a polymer panel. For example, as illustrated in FIG. 2A-2C, the manufacturer can use the printed mold 100a (FIG. 1A) to create a corresponding embossment pattern on a surface of a polymer panel 140a (e.g., by pressing the printed mold 100a against the polymer panel 140a). The polymer panel 140a can comprise, for example, PETG, which can have a glass transition temperature of about 178° F., illustratively. As noted above, the printed mold 100a and/or substrate 130 thereof can have a higher glass transition temperature than the polymer panel 140a, so as to minimize expansion/contraction and deformation of the printed mold 100a while processing the polymer panel 140a. Similarly, the printed and/or cured ink deposited on the substrate 130 can have a melting, deformation, and/or other temperature higher than the glass transition temperature of the polymer panel 140a, so as to minimize alteration, deformation, etc. of the embossment and/or texture pattern during processing of the polymer panel 140a.

In one or more implementations, the printed mold can comprise polycarbonate, which can have a glass transition temperature of about 289° F. In additional and/or alternative implementations, the printed mold can comprise Acrylic, which can have a glass transition temperature of about 212° F. Thus, one will appreciate that printed molds and polymer panels can comprise a variety of materials, components, substances, and/or elements without departing from the scope of this disclosure. In any event, the manufacturer can heat the polymer panel 140a and/or the printed mold 100a, such that at least some of the material on or near the surface of the polymer panel 140a is above or near glass transition temperature of the polymer panel 140a. Consequently, as the manufacturer presses the printed mold 100a against the polymer panel 140a, the material of the polymer panel 140a can deform about the raised, un-raised, and/or recessed areas in the printed mold 100a, thereby forming the finished polymer panel 140a. In particular, the raised areas 110 of the printed mold 100a can form indents/indentations and/or indented areas 111 in the polymer panel 140a, while the unraised areas 120 of the printed mold 100a can leave un-indented areas 121 in the polymer panel 140a, thus providing a mirrored, negative pattern, texture, and/or embossment in the polymer panel 140a or on the surface thereof. Likewise, recessed areas (not shown) in the printed mold 100a can form raised, embossed, and/or protruding textured areas (not shown) in the polymer panel 140a.

In one or more implementations, the manufacturer can use a release agent to facilitate removal of the raised areas 110 of the printed mold 100a from the polymer panel 140a. Moreover, the releasing agent can aid in preventing the ink from chipping, flaking, and/or lifting off the embossing panel or printed mold 110a and/or sticking to the polymer panel 140a. For instance, the manufacturer can use a mold release agent (e.g., LOCTITE® FREKOTE®), a mold release film or sheet, or other release agents to reduce adhesion between the raised areas 110 of the printed mold 100a and the polymer panel 140a and to facilitate separation therebetween.

Furthermore, as discussed above, the raised areas 110 (including intermediate raised areas) in combination with the recessed and/or unraised areas 120 can form embossment and/or texture patterns, which the manufacturer can transfer from the printed mold 100a onto the polymer panel 140a (e.g., thus forming indented areas 111, protruding areas (not shown), and/or un-indented areas 121, respectively, therein). Consequently, the manufacturer can select appropriate height, shape, and size of the raised areas 110 to form the desired embossment and texture patterns on the polymer panel 140a. For example, the manufacturer can apply ink onto the substrate 130 in the form of droplets. The size and shape of such droplets can vary from one implementation to another. For instance, droplets can comprise circular, rectangular, or other shaped dots, lines, blocks, boxes, or any suitable shape, design, and/or configuration. By controlling the size and shape of the droplets of ink applied onto the surface of the substrate 130, the manufacturer can produce a desired texture on the printed mold 100a.

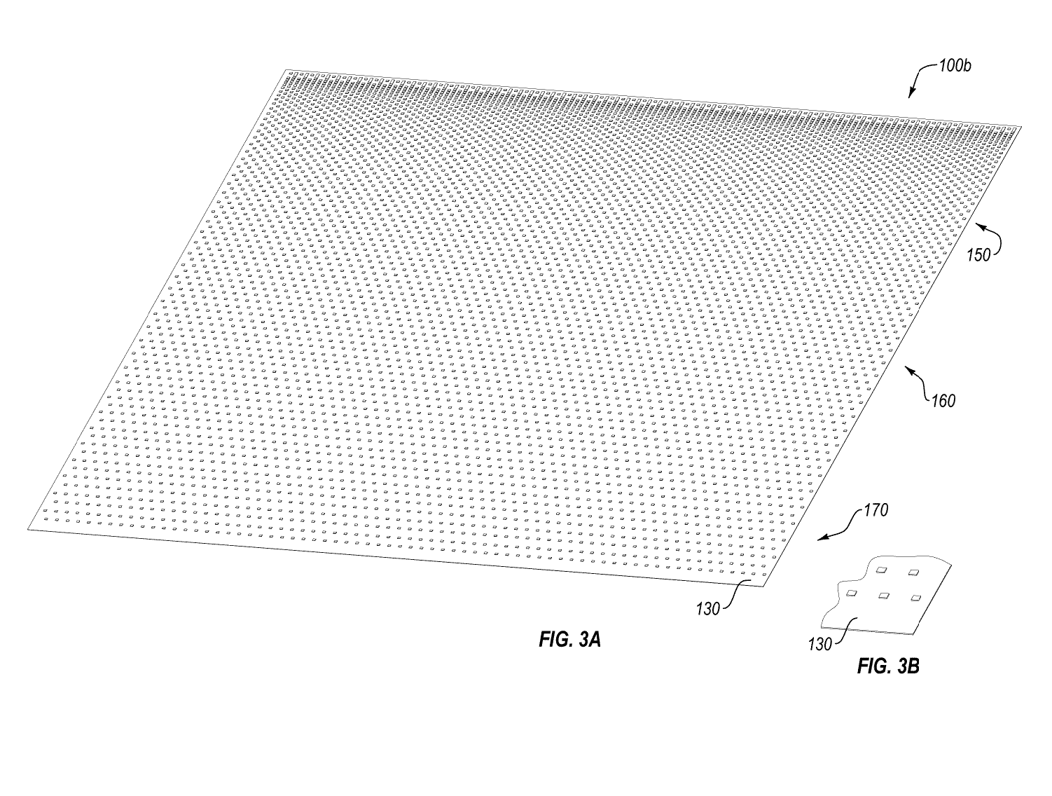

In at least one implementation, the density of droplets on the surface of the substrate can correspond with the density or coarseness of texture imparted by the printed mold onto the polymer panel. For example, as illustrated in FIG. 3, the manufacturer can apply ink to a substrate 130, forming a printed mold 100b, and can form areas thereon that may have different texture or coarseness (e.g., areas with different densities of droplets). The droplets that have a greater size and/or less spacing therebetween can form a rougher or more textured pattern than the droplets of lesser size and/or with more spacing therebetween. In the illustrated example, the droplets can form a gradient—e.g., the printed mold 100b can have a dense area 150, a medium density area 160, and a light area 170.

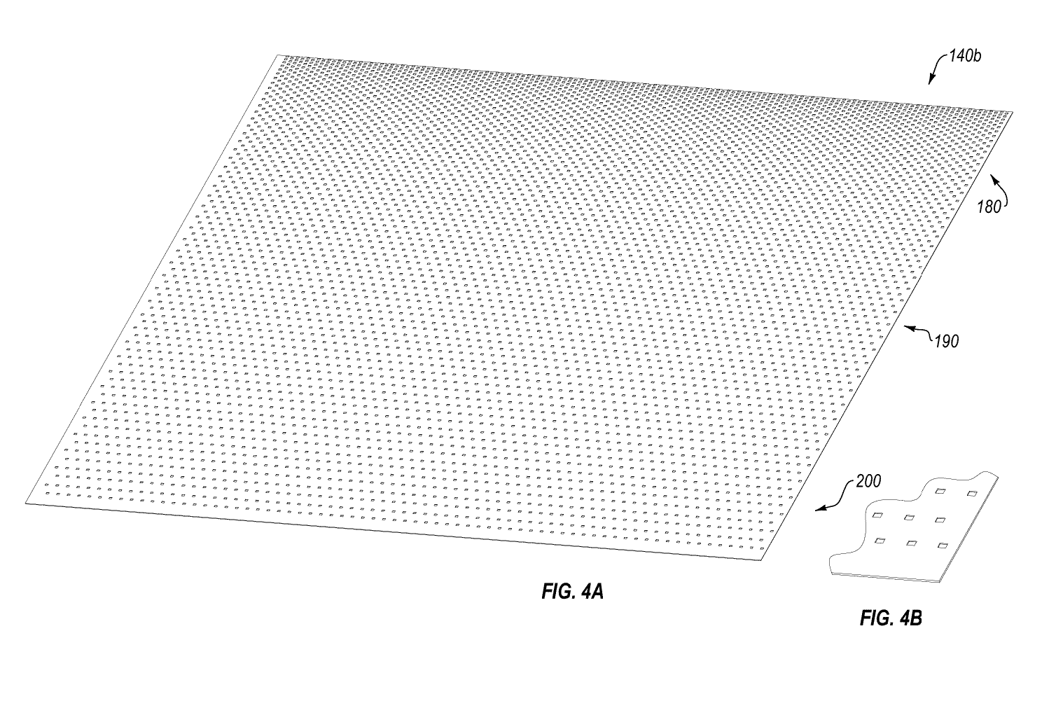

Moreover, the density of droplets on the printed mold 100b, and consequently the coarseness or roughness of the texture imparted onto the polymer panel (e.g., polymer panel 140b of FIG. 4) can correspond with a desired grayscale value of a digital or other image. More specifically, each pixel of a grayscale digital image can have a grayscale value that corresponds with the intensity of black-to-white color at that pixel. Hence, as the value of the grayscale increases at a particular pixel, that pixel can change from white, to gray, to black. Similarly, the grayscale value of a pixel in a grayscale digital image can correspond with density of droplets of ink at a particular location on the surface of the substrate 130. Thus, a higher grayscale value can correspond with a greater density of droplets of ink (i.e., bigger droplets and/or tighter spacing), and a lower grayscale value can correspond with the lower density of droplets of ink (i.e., smaller droplets and/or more spacing) at a particular location on the surface of the substrate 130.

For example, the manufacturer can use a digital image of a grayscale gradient to print the embossment plate or printed mold 100b. Particularly, the printer can deposit more droplets and/or droplets closer to one another in the dense area 150, which can correspond with an area of the digital image that has the greatest grayscale values. Similarly, the printer can deposit fewer droplets and/or droplets spaced farther apart in the medium density and light areas 160, 170, which can correspond with the areas on the digital image that have medium and low grayscale values, respectively. Accordingly, the manufacturer can produce a three-dimensional representation of essentially any two-dimensional image. For instance, the manufacturer can use grayscale photographs to create corresponding patterns on the printed mold 100b. Thus, two-dimensional, grayscale images and/or reference elements can code for a specific pattern, application, and/or amount of ink to be deposited on a substrate 130 to thereby form a three-dimensional embossment, pattern, texture, and/or representation of the two-dimensional image and/or reference element on the printed mold 100b such that three-dimensional pattern or texture can be transferred to a polymer panel 140b to form and/or apply said pattern or texture thereon or thereto.

Accordingly, similar to the printed mold 100a (FIG. 1A), the manufacturer can use the printed mold 100b to create embossments and/or texture patterns on a polymer panel. Particularly, as illustrated in FIG. 4, the manufacturer can use the printed mold 100b (FIG. 3) to emboss and/or texture a polymer panel 140b. Particularly, the dense, medium density, and light density areas 150, 160, 170 of the printed mold 100b (FIG. 3) can form corresponding coarse, medium texture, and light texture areas 180, 190, 200 on the polymer panel 140b.

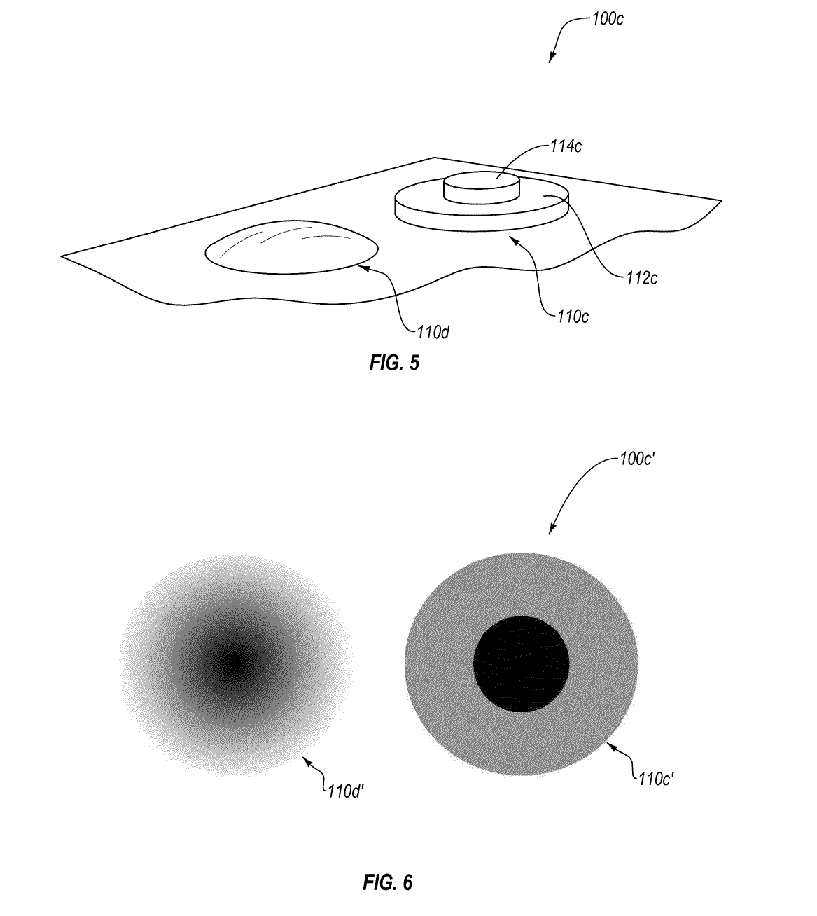

As mentioned above, the raised areas of the printed mold can comprise one or more layers of ink. In particular, the manufacturer can overlay multiple layers of ink to form various three-dimensional structures on the surface of the printed mold. For instance, as illustrated in FIG. 5, the manufacturer can fabricate a printed mold 100c, which can have raised areas 110c, 110d thereon.

In at least one implementation, the raised area 110c can have a first layer 112c and a second layer 114c. The manufacturer can initially print the first layer 112c. Furthermore, the manufacturer also can cure the first layer 112c before printing the second layer 114c. In any event, the manufacturer can create a three-dimensional raised area 110c that has distinct first and second layers 112c, 114c, which together can form a stepped three-dimensional raised area 110c. One will appreciate that such “stepped” areas can comprise substantially vertical “steps” (i.e., substantially perpendicular rises from the surface of the substrate). Similarly, stepped areas can comprise sloped, diagonal, rounded, jagged, or other configurations of steps without departing from the scope of this disclosure.

In one or more implementations, the manufacturer can form a gradually sloping three-dimensional raised area 110d. For example, similar to the raised area 110c, the manufacturer can print a first layer that can form a portion of the raised area 110d and a second layer, which can form another portion of the raised area 110d. It should be appreciated, however, that the first and second layers of the raised area 110d can have substantially no visible steps or separation therebetween. Accordingly, the first and second layers of the raised area 110d can together form a substantially uniform, smooth, and/or gradually sloping raised area 110d.

Moreover, as described above, the manufacturer can create the three-dimensional raised areas (such as the raised areas 110c, 110d) from a two-dimensional pattern. In other words, the manufacturer can transform and/or convert a two-dimensional image, graphical input, and/or reference element into a three-dimensional representation or pattern thereof on the printed mold (e.g., on the printed mold 100c). Specifically, in one implementation, to fabricate the three-dimensional areas 110c, 110d (FIG. 5), the manufacturer can use a two-dimensional image 100c′, illustrated in FIG. 6.

In particular, the manufacturer can use a two-dimensional representation 110c′ to print the three-dimensional raised area 110c (FIG. 5). Likewise, the manufacturer can use a two-dimensional representation 110d′ to print the three-dimensional raised area 110d (FIG. 5). For instance, areas on the two-dimensional representations 110c′, 110d′ that have higher color density can translate into additional printed layer and/or greater height of the three-dimensional raised areas 110c, 110d (FIG. 5).

In at least one implementation, the sharp contrast between the inner and outer regions of area 110c′ can represent and/or translate into a substantially perpendicular step or a substantially vertical rise from the surface of the substrate. Accordingly, such a contrast can code for a distinct transition between layers of ink on the printed mold 100c. Similarly, the gradual transition or gradient of change in the contrast between regions of area 110d′ can represent and/or translate into a gradual rise from the surface of the substrate. Accordingly, such a gradual transition can code for a slow, gradual, and/or substantially imperceptible (i.e., substantially no visible steps or separation) transition between layers of ink on the printed mold 100c.

Moreover, in at least one implementation, the ink can be opaque, transparent, and/or translucent. Accordingly, for example, the three-dimensional raised areas 110c, 110d (FIG. 5) also can be opaque, transparent, and/or translucent (or comprise opaque, transparent, and/or translucent ink). Thus, such three-dimensional raised areas, when printed on a sheet or other substrate, can form textures and/or patterns thereon. Also, it should be appreciated that the two-dimensional representations 110c′, 110d′ can comprise any color or combination of colors and may be used to form the three-dimensional raised areas 110c, 110d (FIG. 5) that also can comprise any single color or combination of colors.

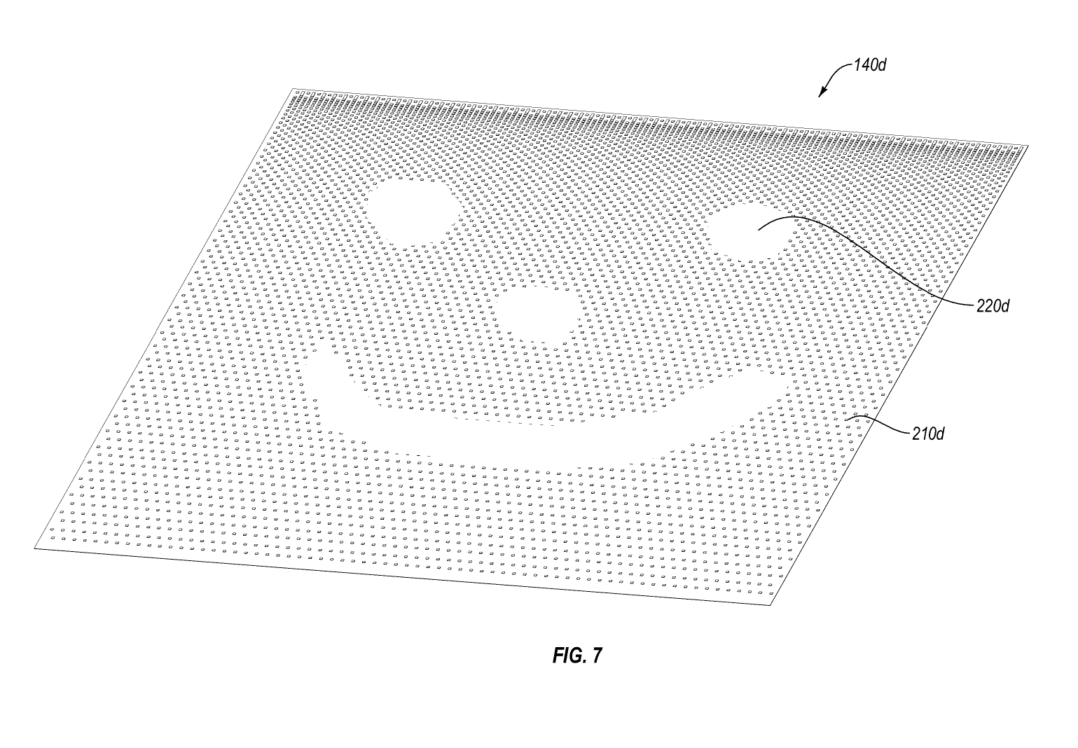

In one or more implementations, the printed mold may have portions without raised areas thereon (e.g., unraised areas and/or recessed areas). Accordingly, by omitting raised areas from certain portions of the printed mold, the manufacturer can avoid indenting, embossing, and/or texturing corresponding portions of the polymer panel. For example, as illustrated in FIG. 7, a finished, embossed, and/or textured polymer panel 140d can include textured and/or embossed areas 210d and untextured areas 220d. Furthermore, the textured and/or embossed areas 210d as well as the untextured areas 220d can have various shapes, sizes, and relationships therebetween. Thus, the manufacturer can create various designs (e.g., letters, figures, pictures, etc.) by coordinating the sizes and shapes the textured and untextured areas 210d, 220d.

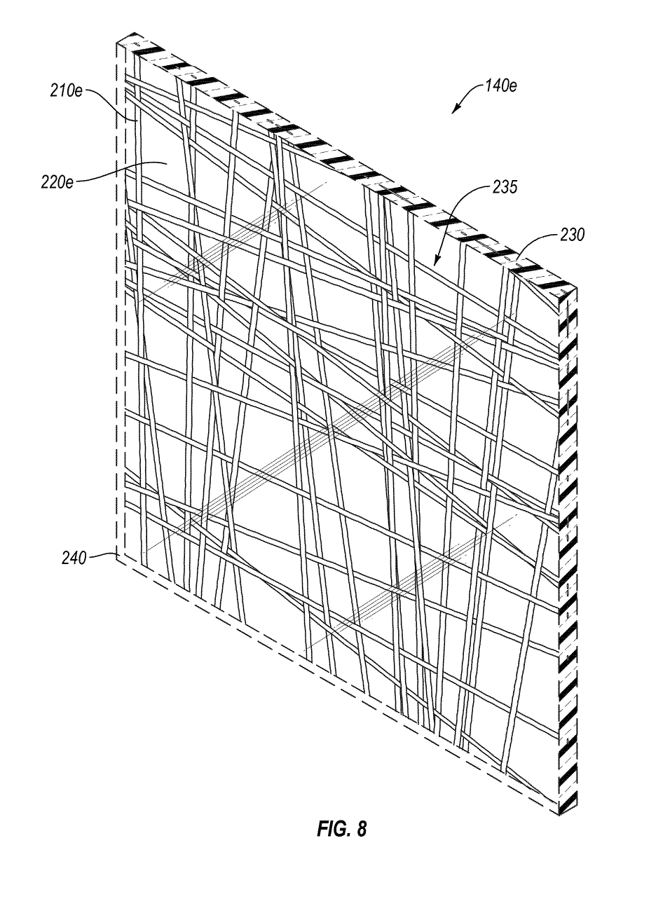

Similarly, as noted above, the textured and untextured areas on the polymer panel also can correspond with one or more portions of an interlayer of the polymer panel. For example, as illustrated in FIG. 8, a polymer panel 140e can incorporate an interlayer 230. For instance, in the illustrated implementation, the interlayer 230 comprises multiple overlapping strings 235.

In one or more implementations, the interlayer 230 is visible through a front surface 240 of the polymer panel 140e. Similar to the polymer panel 140d (FIG. 7), the polymer panel 140e can have textured areas 210e and untextured areas 220e. The textured areas 210e can correspond with the visible portions of the interlayer 230. In other words, the polymer panel 140e can have textured areas 210e at approximately the same locations as the strings 235. In addition to providing a pleasing aesthetic, adding textured areas 210e to the front surface 240 of the polymer panel 140e can provide an observer with a tactile appreciation for the pattern and/or design of the interlayer 230. Alternatively, the untextured areas 220e can correspond with the visible portions of the interlayer 230. Moreover, contrast between the textured (and/or embossed) and untextured areas 210e, 220e can create a three-dimensional appearance of at least a portion of the interlayer 230, on or out of the front surface 240.

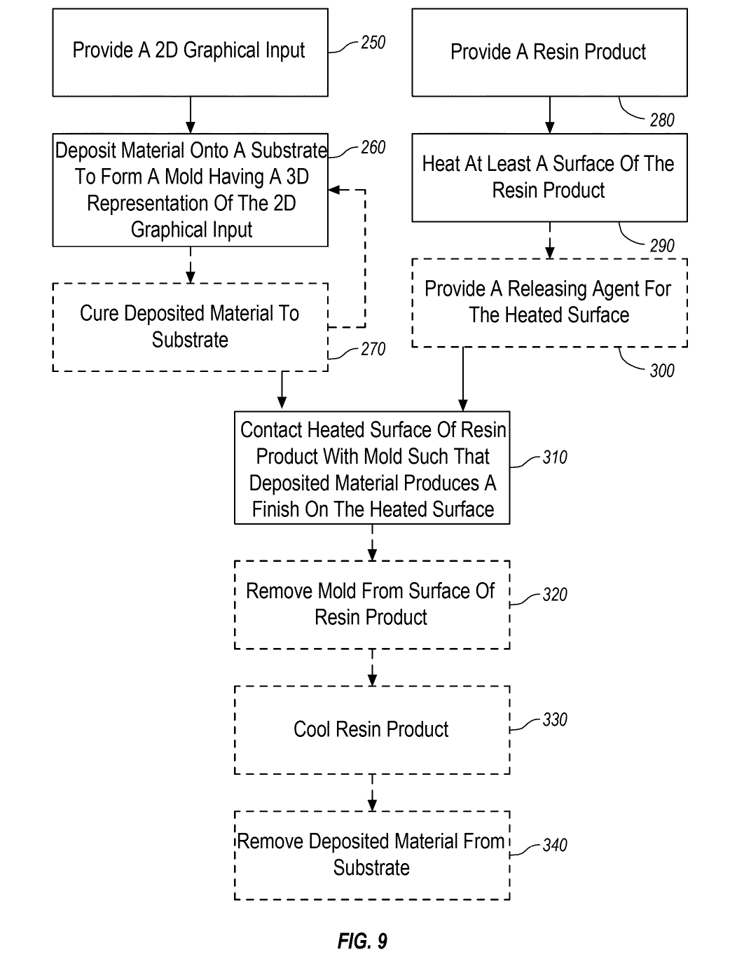

Additionally, one or more implementation of the present disclosure can be described in terms of acts, for example, as illustrated in FIG. 9. Particularly, FIG. 9 illustrates a method of forming a finished, embossed, and/or textured polymer panel and/or manufacturing a mold configured to provide the same. In at least one implementation, the method can include an act 250 of providing a two-dimensional image. As noted above, such image can include a photograph, a design, or other graphical representation, which may be in a digital format.

Furthermore, the two-dimensional image can be in color, black-and-white (i.e., can have only two colors), grayscale, sepia, or other forms of representation. Such images also can include images of embossment and/or texture patterns or locations therefor. For example, the manufacturer can take a photograph of an existing pattern to be matched, or of all or portions of an interlayer visible through the front surface of the polymer panel. Subsequently, the manufacturer can use such photograph as the two-dimensional image provided in the act 250.

The method can optionally include an act of converting the two-dimensional image, photograph, design, or other graphical representation, into a graphical input. For instance, in certain implementations, a color or other photograph, painting, or other reference element can be converted into a two-dimensional image compatible with the printing and/or depositing process(es) described herein. Illustrative conversions can include digitizing, photocopying, and/or otherwise processing the image into a usable format. Thus, the method can also include providing a two-dimensional reference element from which a graphical input image can be derived.

In certain illustrative implementations, a three-dimensional reference element can be provided, from which a two-dimensional (graphical input) image can be derived. For instance, the method can include converting a three-dimensional object (e.g., sculpture, building, oil painting, etc.) into a two-dimensional image, photograph, design, or other graphical representation. Accordingly, the graphical input can comprise a two-dimensional representation of the three-dimensional object or reference element.

The method also can include an act 260 of depositing material onto a substrate to form a printed mold with, having, and/or comprising a three-dimensional image. More specifically, the manufacturer can use the two-dimensional (graphical input) image to determine locations, sizes, shapes, density, height, number of layers, etc. of the deposited material. For example, in one implementation, the deposited material can be ink, and the manufacturer can print the three-dimensional image directly onto the substrate by depositing one or more layers of the ink thereon. Moreover, the manufacturer can vary density, etc. of the printed droplets on the substrate to correspond with the information from the two-dimensional image (e.g., pattern, grayscale values, etc.).

In at least one implementation, the manufacturer can use one or more photographs of the visible portions of the interlayer to deposit material on the substrate at locations that can correspond with the interlayer. As used herein, the term “correspond” can refer to overlapping on the one hand, and avoiding on the other hand. Thus, the manufacturer can deposit material on the substrate at locations that can correspond with the interlayer by depositing material at locations that do not overlap with the interlayer element(s). The substrate and deposited material can comprise a mold or printed mold capable or making an embossment, imprint, texture, or other design in a polymer product or panel.

In certain implementations, the method can include an act 270 of curing or otherwise processing the deposited material. For instance, ink that has been printed on the substrate can be UV cured to create a semi-permanent bond therebetween. Alternatively, certain deposited materials may be cured, at least partially, before being deposited on the substrate.

Some implementations can include additional depositing acts such that the mold or substrate thereof comprises a one or more layers of deposited material. For instance, a manufacturer can print multiple layers of ink so as to form three-dimensional design elements on the surface of the substrate. Such design elements can include one or more levels, steps, or elevations of ink or other deposited material. For instance, the method can include depositing a first layer of material, curing the first layer of material, and depositing a second layer of material atop at least a portion of the first layer of material.

The manufacturer can also use the printed mold to form embossment and/or texture patterns on a polymer product or panel, which can match or otherwise correspond with the visible portions of the interlayer. Thus, in certain implementations, the method can also include an act 280 of providing a polymer product, an act 290 of heating at least a surface of the polymer product, and an act 310 of contacting the heated surface with the mold such that the deposited material produces a finish on the heated surface. Such acts may be termed embossing, texturing, finishing, and/or processing one or more polymer products or panels with the finished (printed) mold.

Accordingly, the method can include transferring the design and/or texture of the printed mold onto the polymer product or surface thereof. In at least one implementation, transferring the design and/or processing the polymer panel with the mold can include heating (and/or applying heat) the polymer material. For instance, processing the polymer panel may include: placing the polymer panel in an oven, autoclave, or other heating apparatus; applying hot air to the surface of the polymer panel; heating and/or pre-heating the mold; and/or any other method known in the art or otherwise for raising the temperature of the polymer panel. Thus, in at least one implementation, heat can be applied through or via the mold whether pre-heated, heated during, and/or heated after contacting the mold with the surface of the polymer product.

In some implementations, the method includes heating the polymer panel (or surface thereof) to about the glass transition temperature of the polymer material. Alternatively, the method can include heating the polymer material to at least the glass transition temperature thereof or to a temperature greater than the glass transition temperature of the polymer material. In at least one implementation, the polymer product is heated to a temperature below the melting, deformation, decomposition, glass transition, or other relevant temperature of the printed mold, substrate, and/or deposited material or ink. Thus, the temperature may by between the glass transition or other temperatures of the polymer panel and mold, wherein the glass transition temperature of the polymer panel is below, less than, or lower than that of the mold.

The method can also include an act 300 of providing and/or applying a release agent to or for the polymer panel and/or printed mold. For instance, a releasing agent can be sprayed, brushed, deposited, and/or otherwise applied between the polymer panel and the printed mold prior to processing. In at least one implementation, the releasing agent is applied before heat is applied and/or before the mold is brought into contact with the polymer product.

The method can also include an act 320 of removing the mold from the surface of the polymer product and/or an act 330 of cooling the polymer product (or vice versa). In certain implementations, the method can also include an act 340 of removing the deposited material from the substrate. For instance, the manufacturer can remove the ink from the substrate and can reuse the substrate, which can further reduce manufacturing costs. Thus, the method can be repeated as necessary or desired to provide additional printed molds.

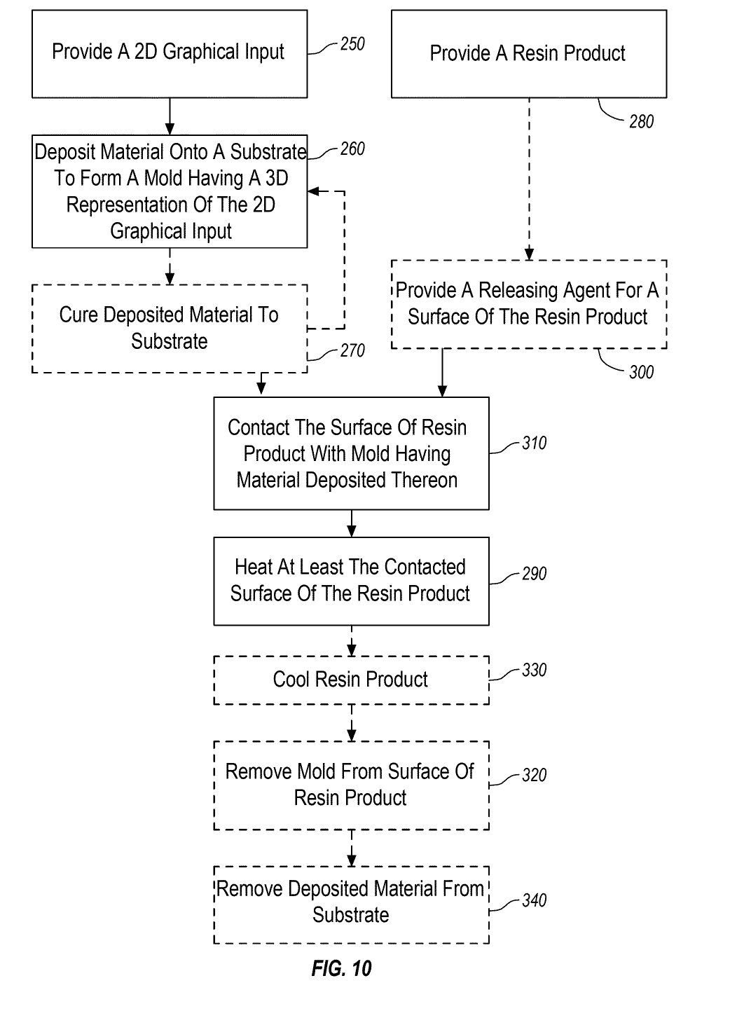

One will appreciate that in some implementations, certain acts or steps of a method can be performed in different order(s) without departing from the scope of this disclosure. For instance, heating at least a surface of the polymer product can be performed after providing a releasing agent in some implementations. As illustrated in FIG. 10, an act 290 of heating at least a surface of the polymer product can even be performed after an act 310 of contacting a surface of the polymer product with a mold having material deposited thereon. Similarly, an act 320 of removing a mold from a surface of the polymer product can be performed after an act 330 of cooling the polymer product in certain implementations.

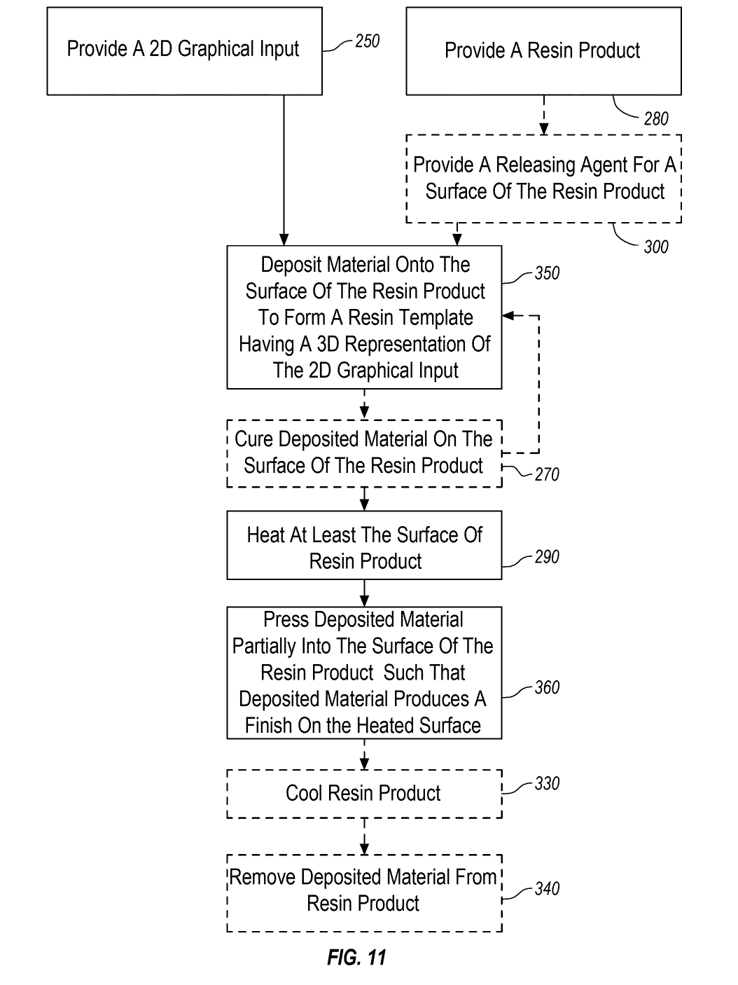

While previous implementations have used a mold comprising a printed substrate to stamp a design, image, or texture onto a surface of a heated polymer panel, such an approach is illustrative only. In other implementations, a mold is not required. For instance, at least one implementation of the present disclosure includes a method of producing a finish on a surface of a polymer product without a mold. As illustrated in FIG. 11, a method can include an act 280 of providing a polymer product and/or an act 250 of providing a 2D graphical input, as described above. Unlike previous implementations, the method can also include an act 350 of depositing material onto a surface of the polymer product. The deposited material can form a 3D representation of the 2D graphical input image or design. In some implementations, a releasing agent may optionally be provided (e.g., applied to the surface of the polymer panel before depositing the material) as in illustrative act 300. Thus, the material can be deposited onto the applied releasing agent in one or more implementations.

The method can also include an act 270 of curing the deposited material (e.g., before, after, or during the act 270). The act 270 of curing the deposited material can be used to solidify an otherwise liquid, gelatinous, semi-solid, or other material, such as a printable ink. Where appropriate, curing can also immobilized the deposited material onto the surface of the polymer product. In at least one implementation, the deposited material can be cured on or to the releasing agent.

The method can also include an act 290 of heating at least a surface of the polymer product. For instance, the method can include heating the surface to which the material is deposited (i.e., has been deposited, will be deposited, and/or is being deposited). Thus, in various implementations, the polymer product (or at least a surface thereof) can be heated at any appropriate and/or suitable time, stage, or step in the method or process. In some implementations, the method can include pre-heating the surface. Other implementations can include, for example, heat pressing the polymer product with material deposited therein. For instance, the method can include an act 360 of pressing the deposited material at least partially into the polymer product or a surface thereof. In an implementation, the pressing act 360 can include or be accompanied by a heating act 290. Thus, the method can also include applying a pressure to at least the surface(s) of the polymer product. The deposited material(s) can thereby produce an image, design, texture, or other finish in or on the polymer panel or surface thereof. For instance, the pressing act 360 can force the deposited material into the heated, softened polymer material, thereby forming indents or indentations in or into at least the surface of the polymer product.

The method can also include an act 330 of cooling the polymer product and/or an act 340 of removing the deposited material from the polymer product or surface thereof. In at least one implementation, the polymer product is cooled before the deposited material is removed. Alternatively, the cooling act 330 can occur or be performed after and/or during the removing act 340. In some implementations, the polymer product is cooled without removing the deposited material. For instance, a method of producing a finish on a surface of a polymer panel can include retaining the deposited material on or in the polymer product. Thus, the deposited material can provide a textured finish in certain implementations. Alternatively, the method can include removing a portion of the deposited material. For instance, a releasing agent can be deposited to a portion of the surface, allowing for a portion of the deposited material (e.g., a portion of the material deposited on or to the releasing agent) to be removed.

The removing act 340 can include applying or otherwise adding a solvent (e.g., if the deposited material is soluble), removing the release agent (and by extension the deposited material) where a releasing agent has been applied, using an adhesive substance where the adhesion level or degree of the adhesive substance to the deposited material is greater than the adhesion level or degree of deposited material to polymer product and/or releasing agent, pressing a substrate or other material onto the surface of the polymer product/deposited material that bonds to the deposited material but does not bond (well) to the polymer product, or any other suitable method or process.

At least one implementation includes a polymer product formed by any of the implementations and/or method(s) described above. Furthermore, finished polymer products (i.e., polymer products having a finish according to at least one implementation disclosed herein) can be further processed and/or utilized in forming additional polymer products. For instance, a textured or other finish polymer product can be thermoformed, bonded, adhered, or otherwise processed together with at least a second polymer, glass, (colored or textured) film, and/or other product or material. At least one implementation can include thermoforming the textured polymer product with an untextured polymer product. The method can include placing the textured surface of a textured polymer panel against a surface of the untextured panel, applying heat and/or pressure to at least one or more surfaces of the two or more panels (i.e., to at least the glass transition temperature of at least one of the panels), and/or cooling the thermoformed product (i.e., below the glass transition temperature).

In certain implementations, additional material(s), elements, and/or other substances, whether decorative, structural, or otherwise, can be placed between such thermoformed panels or other products. For instance, one or more decorative objects, structured cores (e.g., tubes, rods, honeycomb substrates, etc.), and/or other interlayers can be sandwiched between bonded products, whether thermoformed or otherwise processed.

As noted above, some implementations include steps that can be excluded and/or optionally included in other implementations. In one aspect, FIGS. 9-11 can illustratively depict optional steps with dashed boxes and arrows. One will appreciate, however, that optional acts of one implementation can be required acts of another implementation. The present disclosure is intended to set forth various combinations of elements, steps, acts, etc. that can be combined in various orders, combinations, etc. to produce polymer products having a finish thereon or therein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method of manufacturing a printed mold configured to provide a finish on a polymer product, the method comprising:
providing a two-dimensional graphical input; and
depositing material onto a substrate such that the deposited material corresponds to the two-dimensional graphical input.

2. The method of claim 1, wherein the deposited material extends from a surface of the substrate such that a distance between the surface of the substrate and an opposite end of the deposited material can be perceived.

3. The method of claim 1, wherein the deposited material is configured to provide a finish to a surface of a polymer product.

4. The method of claim 1, wherein depositing material onto a substrate such that the deposited material corresponds to the two-dimensional graphical input comprises producing a three-dimensional representation of the two-dimensional graphical input on a surface of the substrate.

5. The method of claim 4, wherein the material is deposited in a pattern similar to a pattern displayed in the two-dimensional graphical input.

6. The method of claim 4, wherein the three-dimensional representation comprises a plurality of layers of deposited material extending from a surface of the substrate.

7. The method of claim 1, wherein the substrate comprises a crystalline structure.

8. The method of claim 1, wherein the substrate is select from the group consisting of a polycarbonate sheet, an aluminum sheet, and a silicone sheet.

9. The method of claim 1, wherein the deposited material is selected from the group consisting of a printable material, a curable material, a UV curable material, ink, printable ink, curable ink, UV curable ink, dye, paint, gel, glue, paste, epoxy, adhesive, and combinations thereof.

10. The method of claim 1, wherein the two-dimensional graphical input is selected from the group consisting of a photograph, a picture, a drawing, a painting, a sketch, a print, a photocopy, and combinations thereof.

11. The method of claim 1, wherein the two-dimensional graphical input is selected from the group consisting of a two-dimensional image, a two-dimensional design, a two-dimensional pattern, and combinations thereof.

12. The method of claim 1 further comprising curing the deposited material.

13. The method of claim 12 further comprising depositing material onto the cured deposited material.

14. A printed mold manufactured by the method of claim 1.

15. A method of producing a finish on a surface of a polymer product, comprising:
providing a polymer product and a mold comprising a substrate having material deposited thereon;
heating at least a surface of the polymer product; and
contacting the heated surface of the polymer product with the mold such that the deposited material produces a finish on the heated surface of the polymer product.

16. The method of claim 15, wherein the polymer product comprises at least one material selected from the group consisting of poly vinyl chloride (PVC); polyacrylate; poly (methyl methacrylate) (PMMA); polyester; poly (ethylene-co-cyclohexane 1,4-dimethanol terephthalate) (PET); poly (ethylene-co-cyclohexane 1,4-dimethanol terephthalate glycol) (PETG); glycol modified polycyclohexylenedimethlene terephthalate (PCTG); 1,4-cyclohexanedimethanol (CHDM); polycarbonate (PC); and combinations thereof.

17. The method of claim 15, wherein the deposited material comprises a three-dimensional formation extending from the surface of the substrate, and wherein the deposited material extends from a surface of the substrate such that a distance between the surface of the substrate and an opposite end of the deposited material can be perceived.

18. The method of claim 15 further comprising manufacturing the mold, comprising:
providing a two-dimensional graphical input; and
depositing the material onto the substrate such that the deposited material corresponds to the two-dimensional graphical input.

19. A polymer product having a finish on a surface thereof, the finish being produced by the method of claim 15.

20. A printed mold for providing a finish, embossing, texturing, or combinations thereof on a polymer panel, the printed mold comprising:
a substrate; and
one or more raised areas coupled to the substrate, the one or more raised comprising a printable ink.
